(19) United States
(12) Patent Application Publication
(10) Pub. No.: US 2006/0111089 A1
(43) Pub. Date: May 25, 2006

(54) System and method for mobile resource management having mobile agent location identification

(75) Inventors: Gregory J. Winter, Chesterfield, MO (US); Daniel D. Huber, Ballwin, MO (US); Naeem Bari, Chesterfield, MO (US)

Correspondence Address: HARNESS, DICKEY, & PIERCE, P.L.C, 7700 BONHOMME, STE 400, ST. LOUIS, MO, 63105, US

(73) Assignee: Agilis Systems, Inc.

(21) Appl. No.: 11/287,132

(22) Filed: Nov. 23, 2005

Related U.S. Application Data
(60) Provisional application No. 60/631,293, filed on Nov. 24, 2004.

(51) Int. Cl. H04Q 7/38

(52) U.S. Cl. 455/414.1; 455/456.1

(57) ABSTRACT

A mobile resource management system and method for managing the arrival of a mobile agent at a location of a customer, the system including a mobile agent location module, a customer communication module, and a mobile agent communication module. The mobile agent location module is configured for identifying a location of a mobile agent and the customer communication module configured for transmitting a notification to a customer of an availability of the mobile agent for arrival of the mobile agent at a location of the customer as a function, at least in part, of the identified mobile agent location, prompting the customer to confirm the arrival of the mobile agent at the customer location, and receiving a confirmation from the customer in response to the prompting. The mobile agent communication module is configured for transmitting schedule and customer appointment information to the mobile agent in response to receiving the customer confirmation.

### CROSS-REFERENCE TO RELATED APPLICATIONS

This application claims the benefit of U.S. Provisional Application No. 60/631,293, filed on Nov. 24, 2004. The disclosure of the above application is incorporated herein by reference.

### FIELD

The present disclosure relates to mobile resource management systems and, in particular, relates to location-based resource management of mobile agents.

### BACKGROUND

The statements in this section merely provide background information related to the present disclosure and may not constitute prior art.

The growth in mobile wireless communications services has presented business and government entities with the ability of improving the management of resources, such as agents, to provide services to customers. The evolving mobile communications services landscape includes, but is not limited to, land-based cellular voice and data services, satellite-based services targeted to trucking transportation markets, two-way paging services, Personal Communications Services (PCS), cellular-based Short Messaging Service, and unlicensed wireless internet access services.

Often services based a on Geographic Positioning Satellite (GPS) or other location based technologies are integrated within existing telecommunication networks as value-added enhancements to core network services to identify the geographic location of a customer or of mobile resources. Examples of location-based services include cellular subscriber emergency location, and value-added motor vehicle “personal security” services, such as General Motor's On Star™ (A registered Trademark of General Motors Company). Associated services can include the management and dispatch of emergency mobile road service assistance.

### SUMMARY

The inventors have designed systems and methods for a mobile resource management system to aid in the management of a mobile resource, such as a mobile agent, to provide the allocation of resources and improved customer service.

According to one aspect, a mobile resource management system for managing the arrival of a mobile agent at a location of a customer, the system including a mobile agent location module, a customer communication module, and a mobile agent communication module. The mobile agent location module is configured for identifying a location of a mobile agent and the customer communication module configured for transmitting a notification to a customer of an availability of the mobile agent for arrival of the mobile agent at a location of the customer as a function, at least in part, of the identified mobile agent location, prompting the customer to confirm the arrival of the mobile agent at the customer location, and receiving a confirmation from the customer in response to the prompting. The mobile agent communication module is configured for transmitting schedule and customer appointment information to the mobile agent in response to receiving the customer confirmation.

According to another aspect, a mobile resource management system includes a customer service module for receiving a request from a customer for a service or product, said customer having a customer location and a mobile agent device associated with each mobile agent and configured for transmitting a signal capable of being used to determine the location of the mobile agent device. The system also includes a mobile agent location module for identifying a location of each of a plurality of mobile agents as a function of the transmitted signal and a system management module configured for determining a task and a task profile as a function of the customer request, determining a status of each of the plurality of agents; selecting a mobile agent to deliver the service or product to the customer from among the plurality of agents as a function of the task profile, the mobile agent status, the customer location, and the mobile agent location. The system further includes a customer communication module configured for transmitting a notification to a customer of an availability of the mobile agent for arrival of the mobile agent at a location of the customer as a function, at least in part, of the identified mobile agent location, prompting the customer to confirm the arrival of the mobile agent at the customer location, and receiving a confirmation from the customer in response to the prompting and a mobile agent communication module configured for transmitting a customer appointment verification, customer location and task profile to the mobile device associated with the selected mobile agent in response to receiving the customer confirmation.

According to still another aspect, a method for managing the arrival of a mobile agent at a location of a customer includes identifying a location of the mobile agent having a mobile agent device and transmitting to a customer a notification of an availability of the mobile agent for arrival of the mobile agent at a location of the customer as a function of the identified agent location. The method also includes prompting the customer to confirm the arrival of the mobile agent at the customer location, receiving a confirmation from the customer in response to the prompting; and transmitting a customer appointment verification to the mobile agent device in response to receiving the customer confirmation.

According to yet another aspect, a method of providing a service or a product to a customer includes receiving a customer request for a delivery of the service or product, determining a task profile as a function of the customer request, identifying a location of each of a plurality of agents, and determining a status of each of the plurality of agents. The method also includes selecting a mobile agent to deliver the service or product to the customer from among the plurality of mobile agents as a function of the task profile, the mobile agent status, and the mobile agent location; and transmitting to the customer a notification of a pending arrival of the selected agent at the customer location as a function of the determined agent status and the location of the selected agent. The method further includes prompting the customer to confirm the arrival of the mobile agent at the customer location, receiving a confirmation from the customer in response to the prompting, and transmitting a customer appointment verification and the task profile to the mobile agent device in response to receiving the customer confirmation.

Further aspects and features of the disclosure will be in part apparent and in part pointed out from the detailed description provided hereinafter. It should be understood that the detailed description and specific examples, while indicating some embodiments of the invention, are intended for purposes of illustration only and are not intended to limit the scope of the various embodiments of the invention.

### BRIEF DESCRIPTION OF THE DRAWINGS

The present invention will become more fully understood from the detailed description and the accompanying drawings. The drawings represent only some of the exemplary embodiments of the invention, as other embodiments are also within the scope of the various embodiments of the invention.

FIG. 1 is a block diagram of a mobile resource management system according to one embodiment of the invention.

FIG. 2 is a block diagram of a mobile resource management system utilizing a wireless communication system according to another embodiment of the invention

FIG. 3 is a block diagram of a mobile resource management system with defined geographic zones according to another embodiment of the invention.

FIG. 4 is a block diagram of a mobile resource management system for tracking a mobile user within authorized geographic zones according to another embodiment of the invention.

FIG. 5 is a block diagram of a computer system according to another embodiment of the invention.

FIG. 6 is a flow chart of a mobile resource management system providing pending delivery notification to a customer according to another embodiment of the invention.

FIG. 7 is a flow chart of a mobile resource management system for notifying a customer of a zone violation of a user according to another embodiment of the invention.

FIG. 8 is a flow chart of a mobile resource management system providing a customer delivery notification according to another embodiment of the invention.

Corresponding reference characters indicate corresponding parts, modules, features, or processes throughout the several views of the drawings.

### DETAILED DESCRIPTION

The following description is merely exemplary in nature and is not intended to limit the present disclosure, applications, or uses.

One exemplary embodiment of the invention includes a system for delivering a plurality of services to a plurality of customers, includes a customer service module, a mobile device communication module, a system management module, and a customer communication module. The customer service module is configured to receive a request for a service from each of the plurality of customers and identify a customer location for each of the customer service requests. The mobile device communication module is configured to communicate with a mobile device of each of the plurality of agents, and to receive a location and status of each of the plurality of agents.

The system management module determines a task profile for a task associated with each of the service requests as a function of each of the customer service requests and selects one or more tasks for a particular agent from among a plurality of agents. The system management module selects the tasks as a function of the task profile, the agent status, the customer location, and the agent location. The system management module further provides for scheduling the selected tasks for the particular agent and initiating the mobile device communication module to communicate the task profiles for the scheduled tasks to the particular agent. The customer communication module is configured for transmitting a notification to each customer associated with the selected task profiles as a function of the agent status and the agent location.

In some embodiments, the customer communication module is configured to receive a customer acknowledgement from the customer in response to the transmitted notification and wherein the system management module reschedules the tasks selected for the particular agent in response to a failure in receiving a customer acknowledgement. The system management module can also be configured to reschedule the task in response to the customer communication module failing to receive a customer acknowledgement in response to the transmitted notification and to retransmit the task profiles of the rescheduled task to the particular agent. The customer communication module can also be configured to receive a customer acknowledgement from the customer in response to the transmitted notification and wherein the mobile communication device communicates a customer status message to the particular agent in response to receiving the customer acknowledgement.

The system management module can also be configured to reselect the one or more tasks for a particular agent in response to the customer service module receiving a new request from one of the plurality of customers, said system management module further configured to reselect the one or more tasks for a particular agent as a function of the received new request, reschedule the tasks for a particular agent in response to the reselecting, and retransmitting the task profiles for the rescheduled tasks to the particular agent.

The system management module can also be configured to assign a new task associated with a new customer request received by the customer service module to an agent as a function of a transit distance, a response time, an agent arrival time, and a customer requested time.

In various embodiments, a mobile device location module can be configured to receive the location from the mobile device communication module and to determine a map coordinate for the location. Such mobile device location modules can map the location of one or more agents and such mapping can include an indication of the status of the one or more agents. For example, the system management module can be configured to predict a late arrival of an agent at a customer location, and the mobile device location module can map the customer location with a color indicative of the predicted late arrival. The mobile device location module can also provide a display of a route traveled by one or more agents.

In other embodiments, the system management module is configured to identify one or more agents who have deactivated a mobile communication device. Additionally, the system management module can select a particular agent having a transit distance less than a transit distance of another agent.

In some embodiments, a location-enabled mobile device can include text messaging such that when the mobile device communication module transmits the task profile. The location-enabled mobile device is configured to receive the transmitted task profile. Additionally, such devices can accept an input entered by an agent, such as a job or agent status, and the device can transmit the status to the mobile communication module. In one such embodiment, the agent can enter his time or a project or task time and the system management module tracks the time, for example as a time-clock for time worked by the agent. Similarly, the agent or the system management module can track the expenses associated with the agent's performing an assigned task or track the miles traveled by the agent. In other embodiments, the system management module can be configured to track supplies or equipment utilized by an agent during a task, further comprising an inventory module configured to track inventories of supplies or equipment in response to the utilized supplies. This can also include receiving an inventory of supplies or equipment from a barcode scanner, a Radio Frequency Identification Device (RFID), or other inventory identification system, by way of example. The mobile device communication module can receive an update to the inventory from a barcode scanner associated with mobile device of an agent.

In other embodiments, the system management module can monitor a task status of one or more tasks and interface with an organizational management module that generates a report of the status of each task or the performance of one or more agents.

In other embodiments, a routing module can determine one or more routes for an agent to travel from their agent to the location of a customer. This can also include selecting one or more tasks for a particular agent as a function of optimizing the travel distance and travel time of two or more agents to perform tasks for two or more customers. In other embodiments, the system management module can schedule the tasks selected for the particular agent as a function of optimizing the travel distance and travel time for the particular agent.

Another exemplary embodiment of the invention includes a system for managing a plurality of mobile agents to provide products or services to a plurality of customers, including a system management module, a mobile device communication module, an agent location module, and a customer communication module. The system management module determines a work order for each product or service to be delivered to each of the plurality of customers with each work order including a location of the customer receiving the product or service. The system management module also selects an agent to deliver the product or service to each customer responsive to each work order and determines a notification parameter for communicating a notification to the particular customer. The mobile device communication module provides each of the work orders to one or more agents. The agent location module determines a location of a particular agent of the one or more agents that will deliver a particular product or service to a particular customer at a particular customer location in response to a particular work order. The customer communication module transmits a notification message to the particular customer as a function of the notification parameter, the location of the particular customer, and the location of the particular agent.

In some embodiments, the notification parameter can include a time interval designated as the time prior to an arrival time of the particular agent to the location of the particular customer. The notification parameter can include a variety of user or system defined parameters or characteristics including, by way of example, a communication address or number of the customer. In another embodiment that includes a routing module, the routing module can determine a route to be traveled by the particular agent to the customer location and the customer communication module can transmit the notification message as a function of the route. The routing module can determine the route as a function of a route condition parameter such as, by way of example, an optimization factor, a route distance, a time, a transit time, a cost, and a unit cost.

In other embodiments, the system management module can determine the work order by identifying a piece of equipment or a material or supply that is required by the agent to provide the product or service to the customer. The module may also generate a requisition to an inventory entity or supplier to provide the equipment or supplies to the agent prior to their traveling to the customer location.

In another exemplary embodiment, the invention includes a mobile resource management system that includes a customer service module, an agent location module, a system management module, and a customer communication module. The customer service module receives a request from a customer for a service or product at a customer location. The agent location module identifies a location of each of a plurality of agents. The agent location module can include one or more interfaces for receiving location-based location signals from location devices of each of the plurality of agents. The system management module determines a task and a task profile as a function of the customer request and determines a status of each of the plurality of agents. The system management module also selects an agent to deliver the service or product to the customer from among the plurality of agents as a function of the task profile, the agent status, the customer location, and the agent location. The customer communication module transmits to the customer a notification of a pending arrival of the selected agent at the customer location as a function of the determined agent status and the location of the selected agent.

In one preferred embodiment, the customer service module can be a web-page interface for interfacing with the customer and for receiving the customer request along with the various details required to provide the service or product to the customer.

Generally, the customer request can include a customer requested delivery time and the system management module can select an agent as a function of the customer requested delivery time. The customer request can also include a notification lead time that the customer desires an advanced notification prior to the delivery at the customer location. The system management module can determine an estimated time of arrival of the selected agent at the customer location and the customer communication module can transmit the notification to the customer as a function of the customer notification lead time and the estimated time of arrival.

In some embodiments, a routing module can determine a route between the locations of one or more agents and the customer location and the system management module can select the agent as a function of the determined route, such as an optimization of the travel distance or travel time of one or more agents for traveling to one or more customer locations. The routing modules can determine the routes for multiple agents to travel from their agent location to a single customer location and the system management module can select a particular agent from among the plurality of agents as a function of the determined routes of the two or more agents. In some embodiments, the routing module can determine the route as a function of a route condition parameter selected from the group consisting of an optimization factor, a route distance, a time, a transit time, a cost, and a unit cost, by way of example. Additionally, in other embodiments the routing module can be configured to track a route traveled by an agent and graphically map the tracked route traveled by the agent. The routing module may also be configured to compare the tracked route traveled by the agent against a predetermined route for the agent or an authorized zone or location for the agent. In some embodiments, the agent location module can specify the allowable or authorized geographic zone for the agent and generate a zone violation notification responsive to the location of the selected agent different than the specified allowable geographic zone.

The system management module can receive the route or initiate the transmission of the route to the selected agent or his communication or mobile device, where it may be displayed as a map or as text.

The system can also include a mobile device communication module for communicating with a mobile device of each of the plurality of agents. The mobile device communication module can transmit the customer location, such as a map coordinate or otherwise, to the agent. The mobile device communication module can be configured to transmit the task profile to the selected agent or receive an agent status message from an agent's mobile device. The agent status message can include, by way of example, a status parameter such as an availability of the agent, a pending availability of the agent, a status of a previously assigned task, a task delivery period, and a task completion time. Of course, other parameters and characteristics associated with the customer, the task, or the agent may also be included.

In some embodiments, the system management module can include an agent profile such that an agent is selected as a function of the agent profile or a parameter or component thereof. The agent profile can include an agent characteristic such as, by way of example, a skill, a certification, a grouping, a geographic allocation, and a rating associated with the agent. Additionally, the agent profile can include an equipment characteristic associated with the agent such as, by way of example, a vehicle type or capability, an equipment type or capability, a material type, an inventory of a material, supply or equipment, and an availability of a material, supply or equipment.

In other embodiments, the system management module is configured to determine an arrival time or a transit time of the selected agent at the customer location and the communication module is configured to notify the customer as a function of the determined arrival time or transit time.

In some embodiments of the invention, the task profile can include one or more customer contacts predefined from input from the customer. The customer communication module can notify the customer as a function of the one or more customer contacts. The customer contacts can include, by way of example, a telephone number, an email address, a paging number, an instant messaging address, and an IP address.

The system management module can include an operator interface for receiving an input from an operator. In some cases, an operator may utilize the operator interface to override the automatically selected agent, and select an agent based on the operator input.

The system management module can also determine equipment supply or a material, or quantities thereof associated with or required for the delivery of the requested service or product to a customer or a task. This can also include determining the equipment, supply or materials for the task profile.

The customer service module can receive a customer request that includes a customer requested delivery period and the system management module can select the agent as a function of the customer requested delivery period.

The customer communication module can receive an acknowledgement from the customer in response to transmitting the notification to the customer. In such a case, a mobile device communication module can transmit the task profile associated with the customer to the selected agent in response to the receipt of the customer acknowledgement. In the alternative, when a customer acknowledgement fails or is not received, the system management module can select another task for an agent in lieu of having that agent become idle waiting on a customer availability. In other embodiments, the system management module can select another agent for a task following the customer communication module failing to receive the customer acknowledgement.

In some embodiments, an inventory management module provides for tracking equipment or supplies associated with one or more tasks. The inventory management module can include an interface for receiving inventory data from a barcode scanner, a Radio Frequency Identification Device (RFID), or other inventory identification system.

The inventory management module can also receive inventory data from a mobile device communication module receiving inventory data from a mobile device of an agent.

In another embodiment, an organizational management module can generate one or more reports that can be customized to meet particular operator needs from the variety of data within one or more modules of the system. A report can include operational data such as, by way of example, task completions, performances of an agent or group of agents, working periods for an agent, completions of a type of tasks, pending tasks, rescheduled tasks, task lengths, transmit times, arrival times, deactivations of a mobile device, deviations from a predetermined route by an agent, and violations of an allowable zone by an agent.

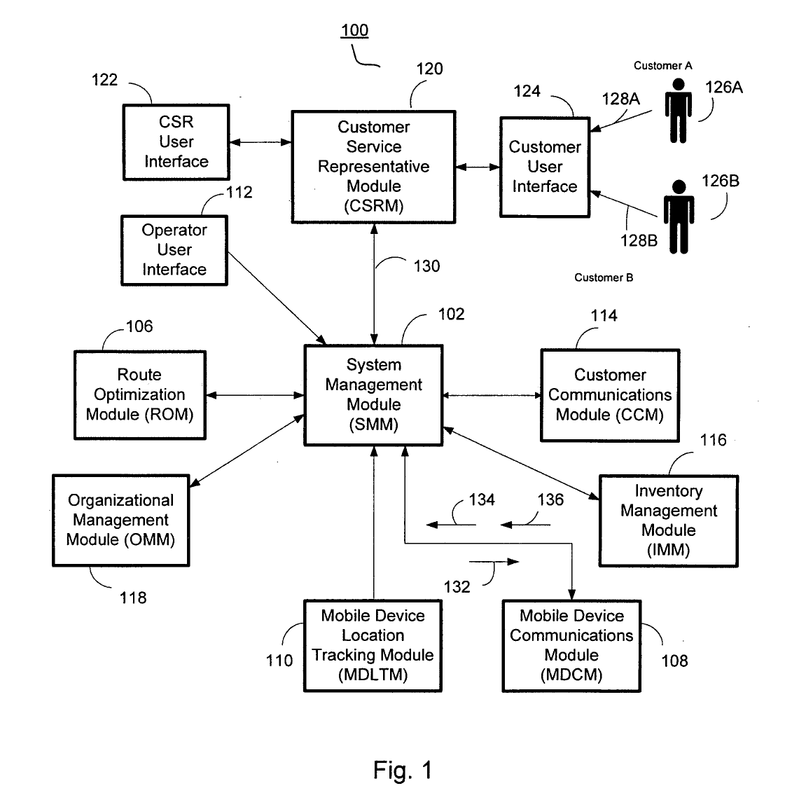

FIG. 1 illustrates a mobile resource management system (MRMS) 100 according to one embodiment of the invention. MRMS system 100 provides a system and method for scheduling and managing mobile resources that deliver and support end-user services on a geographic service area basis.

FIG. 1 illustrates the functional modules of one exemplary embodiment of a MRMS 100 system. System modules are selectable by the end-user and can include any of the following module components: a Customer Service Representative Module (CSRM) 120, a System Management Module (SMM) 102, a Mobile Device Communications Module (MDCM) 108, a Mobile Device Location Tracking Module (MDLTM) 110, a Route Optimization Module (ROM) 106, a Customer Communications Module (CCM) 114, an Inventory Management Module (IMM) 116, and a Organizational Management Module (OMM) 118. Where existing functional modules already exist in an end-user's operations or system, such as the CSRM 120, the MRMS 100 can be configured to interface with other system modules per end user-defined needs.

A given MRMS 100 embodiment can be configured as a single system or as multiple systems deployed within a geographic organizational structure and each can have its own unique customer service area and data base. In other embodiments, one or more modules or sub-modules of the system may share one or more components such as the data base, by way of example.

One processing module within the MRMS 100 is the System Management Module (SMM) 102 that interfaces to other system modules and provides overall management control for a given embodiment. The SMM 102 includes an operator user interface (UI) 112 with the provision for operator input and override of previously scheduled appointments and facilitates manual intervention/override of automated tasks. The SMM 102 can receive input data from the CSRM 120, ROM 106, MDLTM 110, MDCM 108 and IMM 116 modules. The SMM 102 can also receive information requests from the CSRM 120, MDCM 108, or IMM 116 and processes the information requests per user-defined requirements. While these functional modules are illustrated as individual modules, in some embodiments, these functions may be combined in specific end-user defined applications.

The SMM 102 automatically manages individual mobile resource schedules based upon system inputs that can include, but are not limited to, customer service orders, defined job task profiles with standard task intervals, individual mobile resource skill profiles, route optimization schedules for each mobile resource, mobile resource location tracking data and customer contact preferences with associated contact numbers. The SMM 102 can receive manual inputs via the Operator User Interface 112 to override automatically scheduled appointments by the system. Other actions under control of the SMM 102 include, but are not limited to:
1. control and management of the interactions between the SMM 102 and other functional system modules;
2. control of the storage and management of dynamic real-time data necessary to manage and optimize appointment schedules of mobile resources;
3. receipt of mobile resource location data from the MDLTM 110;
4. receipt of customer contact information from the CSRM 120;
5. receipt of customer service order data from the CSRM 120;
6. transmission of job completion data to the CSRM 120;
7. coordination with the MDCM 108 to transmit/receive work order information to/from the mobile resource via user-defined data templates;
8. management of rescheduled appointments when confirmed appointments are not received from the CCM 114.

Functional interactions between the SMM 102 and associated system modules are described within each system module's functions. The MRMS 100 includes data interfaces between the Customer Service Representative Module (CSRM) 120 and the SMM 102. Input data to the CSRM 120 from a customer service representative is accomplished via the CSR User Interface 122. The CSR User Interface 122 can include a web page displayed on a video monitor (CRT) or flat panel screen, mouse, pointing device, voice activation/recognition input, communication link, and keyboard. CSR operator inputs can include, but are not limited to, orders for a particular service, an installation appointment, and a repair appointment, where such appointments can be scheduled based upon particular service intervals for each requested product and service.

The Customer User Interface (UI) 124 to the CSRM 120 can include, but is not limited to, an automated internet web-based portal interface to enter service order/repair requests, local telephone carrier access, and local cellular wireless access. For example, Customer A 126A can access 128A the order entry system using an Internet access to the end-user's Internet site, while Customer B 126B can access the CSRM 120 via local landline and wireless carrier networks 128B.

In some embodiments, the end-user may host their own order-entry web site with its unique universal resource link (URL) Internet address that can include a home page and links to other hosted web pages. In other embodiments, the end-user may outsource the management of the web site to an Internet Service Provider (ISP). Customers can directly order services via the Internet through customer selected menus that have been defined by the end-user. The customer interface to the web-based portal pages that reside on the end-user's server is provided by customer-owned browser software. Browser software in common use includes, but is not limited to, browsers offered by Microsoft and Netscape, that reside on a customer's personal computer. Hosted web pages are end-user designed/defined and coded in various mark-up languages such as, but not limited to, hypertext mark-up language (HTML), extensible mark-up language (XML) and other device-specific mark-up languages. Customer product and service selections are typically chosen from a series of drop-down menu choices. Once the menu of order entries is completed, the customer typically “clicks” on a graphical submit button using a mouse and the order information is passed from the web portal server to the end-user's order entry system and the SMM 102.

Additional end-user specified information captured by a customer service representative or a web portal page during a customer contact can include, but is not limited to, the customer's preferred contact number for appointment follow-up/notification and appointment confirmation, alternative telephone contact number(s), customer's email address, customer pager number, date of initial contact, time of initial contact, special installation requirements, unique access issues, presence of pets, etc.

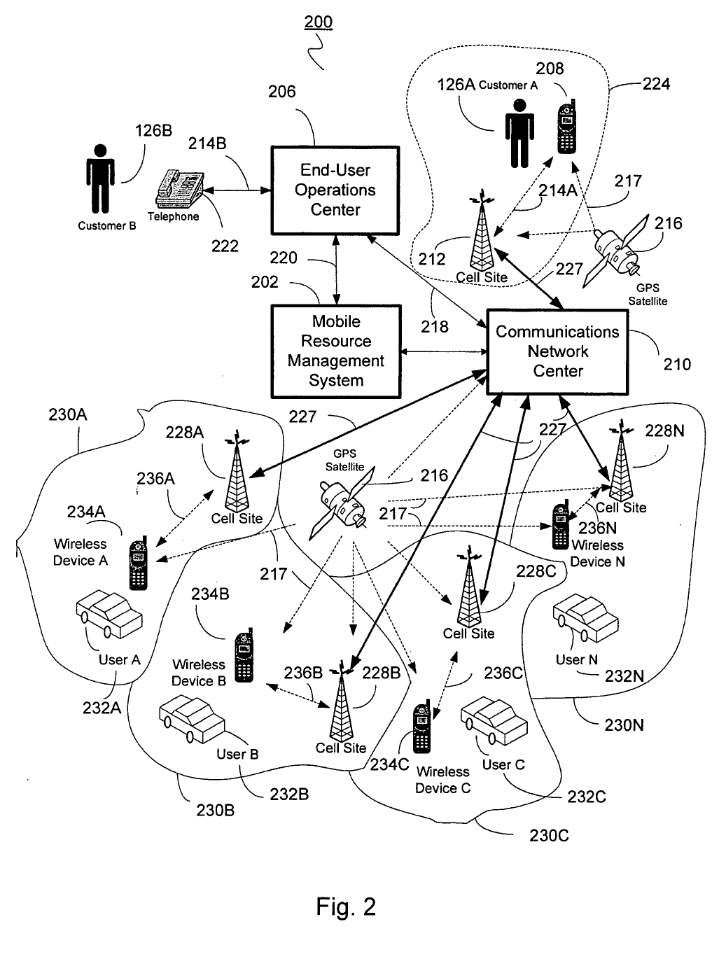

The Mobile Device Communications Module (MDCM) 108 manages communications to wireless devices via user-defined data screen templates utilizing the communications protocol required by a carrier's communications interfaces and the wireless device. While the exemplary embodiment illustrated in FIG. 2 communicates data templates to the display screen of a cellular phone, other embodiments can include templates for wireless personal digital assistants, wireless personal computers or special purpose wireless communications devices as specified by the end-user. Such templates can require coding information in various mark-up languages unique to a given device, such as XML, HTML, etc. Communications interfaces can use any of the previously mentioned wireless access technologies and their associated communications protocols (e.g., 802.11a, 802.11b, 802.11g, X.25, etc.) but is not limited to these technologies.

The wireless device used by the mobile resource receives and displays user-defined work order details for scheduled appointments and can also include additional task and job completion field entries that are completed by the mobile resource upon job completion and transmitted to the MDCM 108 via the carrier or private radio network to confirm the completion status for scheduled job tasks. Upon job completion, the MDCM 108 can communicate or update information for the next scheduled service appointment assigned to the mobile resource and transmit the updated template information via the appropriate network and network interface. Other information that can be communicated to/from the MDCM 1108 via user-defined templates can include, but is not limited to, job status updates, time management data such as clock-in/clock-out, odometer readings between appointments, inventory used for a given appointment, or other user-defined information templates.

The SMM 102 interfaces to the Mobile Device Location Tracking Module (MDLTM) 110 to periodically or continuously receive an update location-based physical coordinate location data that monitors and tracks the position and travel of the mobile device used by the mobile resource throughout the user-defined work schedule. The MDLTM 110 can be executed using third-party software, such as GPStrac provided by LADS Network Solutions according to one embodiment. Location data per mobile resource device is maintained within the MSRM 100 for access by the system operator to display resource travel history by user-defined geographic areas or user-defined service area maps. Such location and map information can be used by the system operator to re-schedule appointments, as needed, based upon the closest available resource and the system operator can override and re-schedule a previously assigned appointment. The system operator has the capability to display route activity for an individual mobile resource and for multiple mobile resources as defined by the needs of the end-user.

The SMM 102 interfaces with the Route Optimization Module (ROM) 106 under the control of the system operator. The ROM 106 is executed using third-party software that is generally available or can be customized to a particular embodiment. For a given day's planned activities within the end-user defined service area, the ROM 106 examines total work order demand, the job-skill profiles of available mobile resources, standard task intervals and geographic location of pending orders and allocates work orders to individual mobile resources to minimize travel time and complete the maximum number of work orders. Once individual mobile resource schedules have been determined, the day's scheduled appointments and tasks can be transmitted to the mobile resource via user-defined data screens under the control of the MDCM 108. The optimized route and schedule data can also be accessed by the Inventory Management Module (IMM) 116 to determine the inventory needed by each mobile resource for the day's scheduled activities. Should end-user operational practices in a particular embodiment include daily reporting to a Work Center before departing to the first scheduled appointment, the required inventory can be ready for pick-up by the mobile resource at the start of each scheduled work period. In other embodiments, the end-user can seek to schedule appointments and manage inventory over multiple days or work shifts.

The SMM 102 interfaces to the Customer Communications Module (CCM) 114 to access customer contact requirements and contact information to confirm an appointment and job site access availability as originally scheduled. The CCM 114 schedules communications to the customer for the next appointment for a given mobile resource to confirm access availability for the next service appointment. Customer contact information collected by the Customer Service Representative or web-based portal with the initial customer service request can include home telephone number, work telephone number, email address or pager number or any other communications means preferred by the customer as the preferred contact means. The timing of the Customer contact by the MRMS 100 is user-defined. If the customer confirms the appointment, the system communicates the confirmation to the mobile resource and the mobile resource proceeds to the next appointment. If the appointment is not confirmed, the mobile resource serves the next scheduled appointment after appointment confirmation is received from the next scheduled customer. In other embodiments, the customer contact can only consist of customer notification that the service appointment is “on schedule” along with the time of the scheduled appointment.

The SMM 102 also includes interfaces to the Organizational Management Module (OMM) 118 to access standard operational reports that have been pre-defined by end-user management staff to access resource performance reports and to reallocate resources based upon geographic-specific service demands. Such reports can include user-defined report formats based upon operational needs and industry benchmarking metrics.

The reports from the OMM 118 can be accessed through the operator user interface 112 that can include, but is not limited to, remote personal computer (PC) access via a local area network (LAN), a PC local to the system operator or via requests for printed reports from the system operator staff. Typical reports can include, but are not limited to work orders by day; completed work orders by day, by geographic service area or by individual mobile resource and compiled at the regional organization level and/or by districts within the regional service area.

The SMM 102 interfaces to the Inventory Management Module 116 to maintain an inventory data base on a mobile resource-specific basis based upon scheduled appointments, services requested and spare parts inventory policies. Inventory can be allocated at the associated Work Center on a per mobile resource basis as specified by the end-user's inventory management practices. As completed work orders are communicated to the MRMS 100 using pre-defined data templates received from the mobile device via the MDCM 108, the SMM 102 updates the associated inventory data base. At the end of a given work day, individual mobile resource inventory is updated based upon completed job tasks and the next work interval's scheduled work orders and tasks.

Referring now to FIG. 2, one exemplary end-user embodiment of the MRMS 200 in the end-user's Operations Center communications facilities 206 includes an end-user that has elected to communicate with its mobile resources or agents via a local mobile carrier network that serves the end-user's geographic service area. The local carrier network is represented in this exemplary embodiment by the Communication Network Center 210 and its associated cell sites 228 that provide wireless radio frequency (RF) signal coverage for specific geographic area segments within the carrier's service area.

Other embodiments can include multiple carrier networks or private carrier networks and can include other wireless technologies. Other wireless network technologies can include, by way of example, analog cellular systems with cellular digital packet data (CDPD) overlays, digital cellular Short Message Service (SMS), digital Global System for Mobile Services (GSM), digital cellular systems with code division multiple access (CDMDA) spread spectrum access technologies, General Packet Radio Services (GPRS), digital Personal Communications Services (PCS) technologies, two-way narrowband PCS, two-way paging systems, unlicensed wireless data networks, and satellite communication systems offering Internet-based data communications services. Some or all of these may include one or more forms of location technologies or services.

Location based services (LBS) are being introduced by wireless carriers to provide their customers (and local government-based emergency service entities) information that is location-dependent. The subscriber location can be determined by the coverage area of the cell site presently serving the subscriber. Location accuracy is achieved when the mobile handset signal is received by multiple (3 or more) cell sites and the carrier determines the handset physical location using handset signaling data received from the multiple cell sites. Subscriber-specific location information can include the subscriber's telephone number and the carrier-determined handset physical location. Location based technologies, include, by way of example, global positioning system (GPS), assisted GPS (AGPS), advanced forward link trilateration (AFLT), angle of arrival (AOA), base transceiver station (BTS), enhanced forward link trilateration (EFLT), enhanced observed time difference (EOTD), and time difference of arrival (TDOA).

Referring again to FIG. 2, as one exemplary embodiment, a location based service 217, illustrated by way of example as a GPS satellite system but that can include any location based capability including tower triangulation or otherwise, is integrated within this exemplary embodiment to provide geographic location data to the mobile wireless field devices, such as cellular phones 208 and 234, or other devices such as a laptop PC or PDA configured with a wireless modem or location identification or determination card or module. The location based signals 217 are received and processed by wireless receiving devices to determine the location coordinates of the device/device user. The location based signals 217 can also be processed within software-based mapping systems or location receiving terminals (including those that are commercially available from a variety of sources) to display a geographic position on a graphical map. Other wireless devices can be used in other embodiments that can include personal digital assistants (PDAs), two-way paging terminals, health-monitoring devices or child-tracking devices.

FIG. 2 also illustrates an interface of the MRMS 202 with an end-user Operations Center communication facility 206 that can include customer contact via cellular services 214A or wireline carrier services 214B. Customer A 126A prefers to be contacted by his cellular service 214A, while Customer B 126B prefers to be contacted at his office number over a carrier wireline network 214B. End-user carrier communications services can also include private branch exchange (PBX) equipment, key system equipment, automatic call director (ACD) equipment, traditional central office exchange (Centrex) services or carrier paging services. End-user network embodiments can also include the use of web-based portals, private network facilities (fiber optic facilities, copper facilities, radio network facilities, etc.). The exemplary embodiment of FIG. 2 illustrates how the MRMS 202 functions as the hub for the management of mobile resources within an end-user's customer service operations.

In this exemplary embodiment, the MRMS 202 manages communications and the flow of work order data on a geographically defined basis among operations staff, customers and the mobile resources that deliver and support the services offered by the end-user. Typical end-users can include, but are not limited to: telephone carriers; cable television service providers; satellite television service providers; electric utilities; gas utilities; water utilities; residential service companies such as plumbing contractors, electrical contractors, lawn maintenance services, pest control, and home health care; government services, such as fire, police, road maintenance, and emergency services; and business service companies, such as courier services, janitorial services, office supply firms, etc.

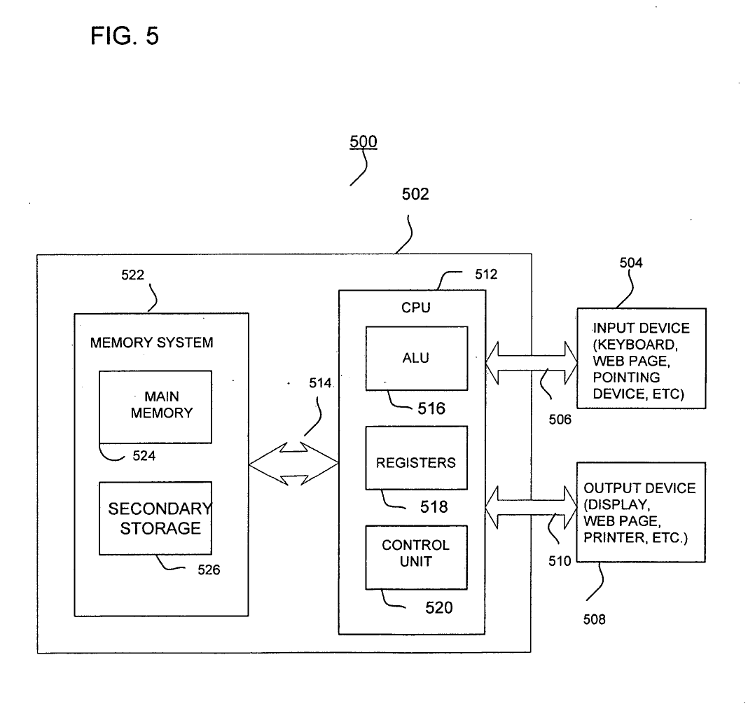

Referring now to FIG. 5, an operating environment 500 illustrates one exemplary embodiment of a computer system 502 for operating one or more components or modules as described above. A computer system 502 includes at least one high speed central processing unit (CPU) 512, a memory system 522, an input device 504, and an output device 508. These elements are interconnected by at least one bus structure 506, 510, and/or 514.

The illustrated CPU 512 is of a familiar design and includes an arithmetic logic unit (ALU) 516 for performing computations, a collection of registers 518 for temporary storage of data instructions, and a control unit 520 for controlling operation of the operating environment system 500. Any of a variety of microprocessors, including at least those from Digital Equipment, Sun, MIPS, Motorola, NEC, Intel, Cyrix, AMD, Hewlett Packard, and Nexgen, is equally preferred for the CPU 512. The illustrated exemplary embodiment of the invention operates on an operating system designed to be portable to any of these processing platforms.

The memory system 522 generally includes high-speed main memory 524 in the form of a medium such as random access memory (RAM) and read only memory (ROM) semiconductor devices, and secondary storage 526 in the form of long term storage mediums such as floppy disks, hard disk drives, magnetic tape media, CD-ROM, flash memory, etc. and other devices that store data using electrical, magnetic, optical or other recording media. The main memory 524 also can include video display memory for storing images and graphics that are transmitted to a display device. Those skilled in the art will recognize that the memory system 522 can include a variety of alternative components having a variety of storage capacities.

The input and output devices 504, 508 are also familiar. The input device 504 can include a keyboard, a mouse, a physical transducer (e.g., a microphone), etc. that may be used to input data to a user interface that can include a web page screen, a program defined input template, etc. Some communications devices, such as a network adapter or modem, can be used as input and/or output devices.

As is familiar to those skilled in the art, the operating environment 500 further includes an operating system and at least one application program. The operating system is a set of software that controls the computer system's operations and the allocation of resources. The application program is a set of software that performs a task desired by the user, using computer resources made available through the operating system. Both are resident in the illustrated memory system 522. When multiple application programs are present within a given system embodiment, as with some embodiments of the invention, these individual application programs are often referred to as modules that are coded to perform specific functions and operational tasks.

In accordance with the practices of persons skilled in the art of computer programming, various embodiments of the invention is described herein with reference to symbolic representation of operations that are performed by the operating environment 500. Such operations are sometimes referred to as being computer-executed. It will be appreciated that the operations that are symbolically represented include the manipulation by the CPU 512 of electrical signals representing data bits and the maintenance of data bits at memory locations in the memory system 522, as well as other processing of signals. The memory locations where data bits are maintained are physical locations that have particular electrical, magnetic, or optical properties corresponding to data bits. Various embodiments of the invention can be implemented in a program or programs, comprising a series of instructions stored on a computer-readable medium. The computer-readable medium can be any of the devices, or a combination of the devices, described above in connection with the memory system 522.

In operation, various embodiments of the invention address various operations, processes and methods of managing the provision of services and delivery of products and services to customers are various customer locations. Other embodiments of the invention address managing the agents delivering those products and services.

One business activity that has been challenging to manage is that of the “missed appointment” or “delayed appointment.” Service appointments are scheduled for the day and the resource assigned to provide the requested services can arrive at a given customer location and find that access to provide the service or product delivery is not available due to customer unavailability or last-minute schedule changes. In such cases, the service provider can have standard business practices to wait for a given time period before moving on to the next scheduled appointment and the service appointment delay often accumulates for subsequent appointments throughout the work schedule.

In other instances, the service provider resource can experience delays in completing work at an earlier scheduled appointment or traffic conditions prohibit the service resource from meeting the next scheduled service appointment or delivery, frequently resulting in customer dissatisfaction. Customer acceptance of the “morning” or “afternoon” appointment wears thin in competitive markets that demand “exceeding customer expectations”.

Various embodiments of the invention address the “missed appointment” or “delayed appointment” events by providing the capability for the system and/or system operator to confirm the next scheduled appointment for a mobile resource by contacting the next scheduled appointee/customer in advance of agent completion of the current scheduled appointment activity for that mobile resource. The advanced contact “time interval” is end-user specified and can be, but is not limited to, a function of the driving distance to the next appointment, the remaining time in the work schedule of the mobile resource, the time required for the scheduled tasks at the next appointment, etc. In another embodiment, the contact interval is specified by the customer at the time of order entry.

In one embodiment of the invention, a method provides a service or a product to a customer and includes receiving a customer request for a delivery of the service or product and determining a task profile as a function of the customer request. A location and status of each of a plurality of agents is determined. The method also includes selecting an agent to deliver the service or product to the customer from among the plurality of agents as a function of the task profile, the agent status, and the agent location. The method further includes transmitting to the customer a notification of a pending arrival of the selected agent at the customer location as a function of the determined agent status and the location of the selected agent.

In yet another embodiment of the invention, a method provides services to a plurality of customers and includes receiving a request for a service from each customer and determining a task profile for a task associated with each service request as a function of each customer service request. A customer location for each customer service request is determined. A location and status of each of a plurality of agents is determined. The method also includes selecting one or more tasks for a particular agent from among a plurality of agents, the selecting being a function of the task profile, the agent status, the customer location, and the agent location. The method further includes scheduling the selected tasks for the particular agent and transmitting the task profiles for the scheduled tasks to the particular agent. A notification to each customer associated with the selected task profiles is transmitted as a function of the agent status and the agent location.

The method can also include rescheduling the tasks selected for the particular agent in response to not receiving a customer acknowledgement to the transmitted notification.

In some embodiments, the method can include receiving a customer acknowledgement in response to the transmitted notification. In such embodiments, a customer status message can be provided to an agent in response to receiving the customer acknowledgement. If a customer acknowledgement is not received, the task can be scheduled and the task profiles retransmitted to the agent.

In another embodiment, a new request from a customer is received and the tasks or agents are reselected as a function of the received new request in consideration of the previous tasks. The tasks can be rescheduled for a particular agent in response to the reselecting and the task profiles can be retransmitted to the particular agent.

The method can also include receiving a new request a customer and assigning the task associated with the new request to a particular agent as a function of a parameter or characteristic such as, by way of example, the transit distance, response time, agent arrival time, agent profile, customer profile, or a customer requested time.

In other embodiments, the method can include mapping the location of one or more agents and can include predicting a later arrival of an agent at the customer location and mapping the customer locations with a color that indicates the predicted late arrivals. Similarly, the mapping can map the location of the agents and can include an indication of the status of the one or more agents, or a route traveled by one or more agents.

In other embodiments, the method can include determining routes for each of two or more agents to travel from their agent location to the locations of two or more customer and selecting one or more tasks for a particular agent as a function of optimizing a travel distance or a travel time for the two or more agents to perform the tasks for the two or more customers at the customer locations.

In still another embodiment of the invention, a method of managing a plurality of mobile agents to provide products or services to a plurality of customers includes determining a work order for each product or service to be delivered to each of the plurality of customers, each work order including a location of the customer receiving the product or service. An agent is selected from among a plurality of agents to deliver the product or service to each customer responsive to each work order. Each of the work orders is provided to one or more agents. The method further includes determining a location of a particular agent delivering a particular product or service to a particular customer at a particular customer location in response to a particular work order. A notification parameter for communicating a notification to the particular customer is determined and a notification message is communicated to the particular customer as a function of the notification parameter, the location of the particular customer, and the location of the particular agent.

In another embodiment of the invention, a method of notifying a customer of a location violation of an agent includes defining an authorized location for the agent, determining a location of the agent, and notifying the customer responsive to the agent location being different than the authorized location.

In some embodiments, the authorized location can include one or more boundaries separating the authorized location from a non-authorized location. In such, cases, the customer can be notified in response to the agent location being equal to a boundary or a non-authorized location.

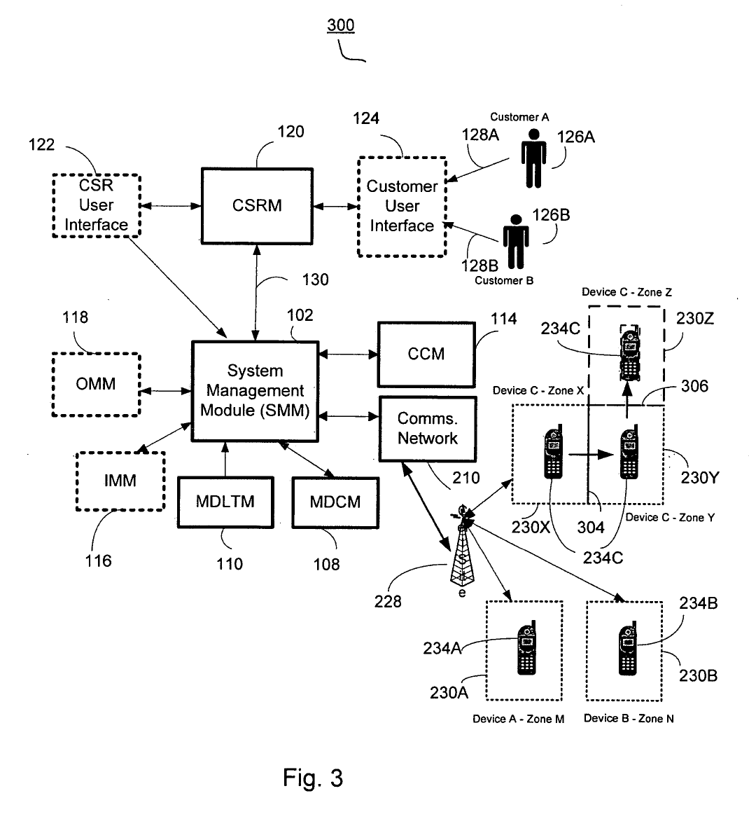

FIG. 3 illustrates one exemplary embodiment of the invention with three mobile resources, reachable via mobile Device 234A, Device 234B and Device 234C, respectively, are currently working their scheduled activities. Worker C, presently in Zone X is scheduled to provide services to Customer 126A in Zone Y and then to Customer 126B in Zone Y. Before mobile resource C completes the current job, the CCM 114 contacts customer 126B for the user-defined time interval prior to the scheduled appointment for mobile resource C to confirm the next scheduled appointment. If the appointment is confirmed, there is no schedule change for mobile resource C and mobile resource C proceeds to the next scheduled appointment. If the appointment is not confirmed, the CCM 114 contacts the next scheduled appointment for mobile resource C to confirm customer availability for an advanced appointment time. If confirmed, the re-scheduled appointment is communicated to Worker C via MCDM 108, mobile resource C acknowledges receipt of the rescheduled appointment and proceeds to the next scheduled appointment. Customer 126A's service appointment must be re-scheduled and the SMM 102 communicates this information to the CSRM 120.

A customer contact User Interface 124 initiated by the CCM 114 can be, but is not limited to, an Automatic Call Distributor (ACD) system that allocates automated calls among CSRs, an interactive voice response system (IVR), an interactive voice recognition system (IVRS), Internet email via an end-user web-based portal, customer pager notification, or Short Messaging Service notification communications, as specified by the end-user system configuration.

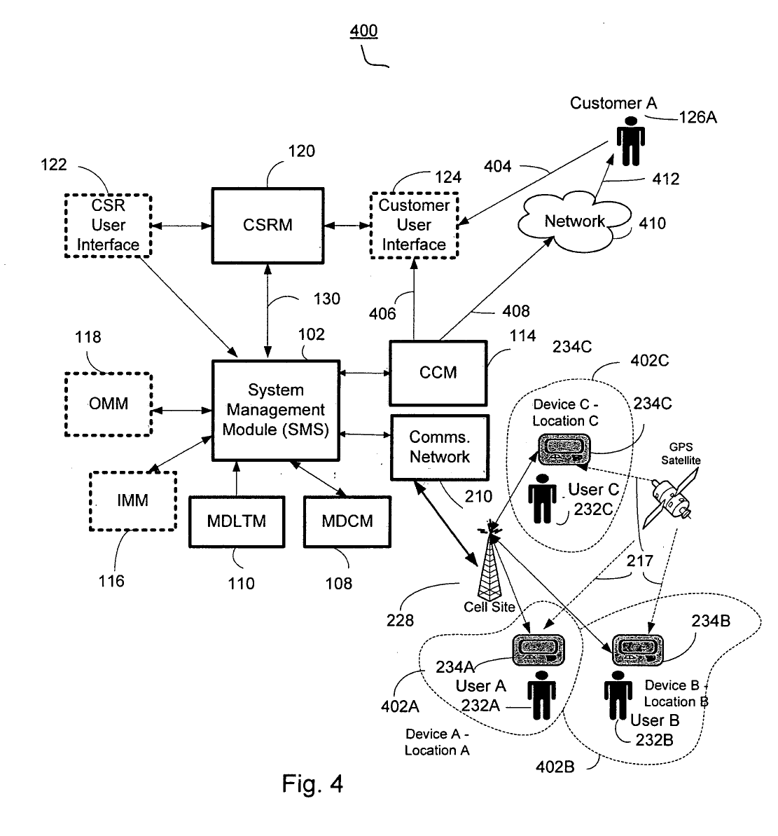

In another embodiment, a mobile resource management system provides for tracking a mobile user within a predetermined or authorized geographically defined zone. FIG. 4 illustrates an exemplary embodiment wherein the MRMS 400 monitors the user-defined geographical location of a plurality of users 232A, 232B and 232C. Each user has a location tracking device that periodically or continuously communicates its location to the MRMS 400 via a cellular network. The end-user for this embodiment has defined a geographic boundary within which a specific user can be located for the plurality of users. Should any of the plurality of users move to a location at the boundary or outside each geographically defined area, the CCM 114 communicates the location violation to the Customer A 126A. Such notification can include, but is not limited to, text messaging, an alerting signal with a text message, a paging message or pre-defined message formats. Exemplary applications of this embodiment can include, but are not limited to, user location monitoring with a prison/detention facility, physical location monitoring of health care patients (e.g., Alzheimer patients, home-bound patients, etc.), and location monitoring of day care students.

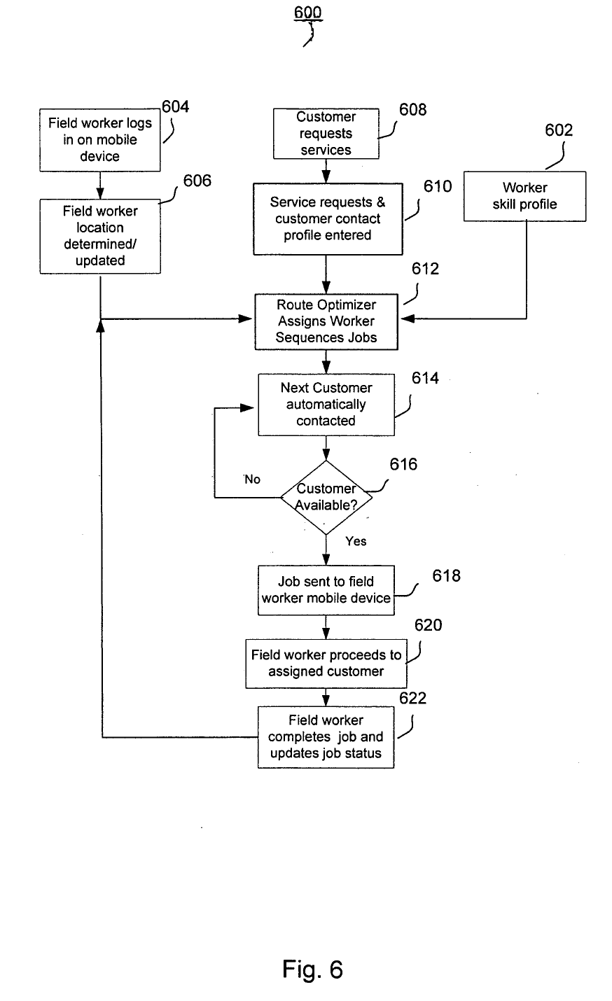

In another embodiment, the mobile resource management system provides a pending delivery notification to a customer. FIG. 6 illustrates one exemplary embodiment wherein an agent/mobile resource receives real-time service delivery requests and scheduled appointments. In this embodiment, the agent logs on to their location-enabled mobile device in 604 at the beginning of their scheduled work period and the physical location coordinates for the device are determined/updated in 606 and transmitted to the ROM in 612 as one input element to allocated customer service requests. The ROM in 612 also receives worker skill profiles in 602 as additional decision inputs for allocation of customer service requests among a plurality of workers/agents. A plurality of customer service requests in 608 are also received by the ROM in 612 that includes contact profiles in 610 for each customer. The ROM 612 assigns the requested tasks to the field worker considering the requested appointment time, worker physical location, customer location and customer contact interval. The CCM 114 automatically contacts the customer to confirm availability field in 614. If confirmation is received from the customer, the job is sent to the field worker mobile device 618; the field worker proceeds to the assigned customer in 620, completes the requested tasks and updates the job status as complete in 622. Upon job completion status entry by the worker, the field worker's location is again determined and updated in 606 and the ROM in 612, again includes the worker within the pool of available resources for the next scheduled appointment. Should the customer not be available in 616, the ROM 612 determines the next candidate customer appointment for the field worker considering the updated worker location, customer location, and customer contact time interval and the CCM 114 contacts the next customer to confirm availability in 614. This exemplary embodiment continues throughout the field worker's scheduled work period. Exemplary applications of this embodiment include but are not limited to, product pick-up and delivery requests from business customers, express mail pick-ups and parts pick-up and delivery.

In another embodiment of the invention, the mobile resource management system provides for notifying a customer of a zone violation of a tracked user. One embodiment includes a system for notifying a customer of a location violation of an agent includes a customer service module, an agent location module, and a customer communication module. The customer service module defines an authorized location for the agent in response to the received request by the customer. The agent location module determines a location of the agent and the customer communication module transmits a notification to the customer in response to the agent location being different than the authorized location.

Such an embodiment can be configured to define the authorized location to include one more boundaries separating the authorized location from a non-authorized location, wherein the customer communication module transmits the notification responsive to the agent location being equal to a boundary or a non-authorized location. The agent location is tracked by a location system and/or location device as discussed generally above. The boundaries, locations or zones can be defined by the customer via a customer interface such as a graphical map on a web-page or may be defined by a system operator. Additionally, a profile for the tracked agent location may be defined to include the authorized location or other items provided by the customer request. Additionally a customer profile may be defined and include one or more parameters and characteristics associated with the customer request. This can include one or more customer contact and alarm notification methods, addresses, and priorities. The customer communication module can utilize the customer profile or the agent profile for transmitting the notification.

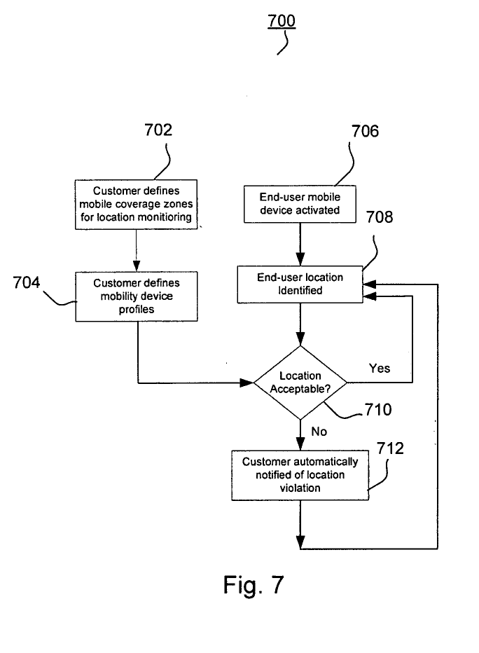

FIG. 7 illustrates one exemplary embodiment wherein the customer application requires “geo fencing” of the end-user. In such applications, the customer defines mobile coverage zones in 701 that are permissible for a plurality of end-users with each end-user having a geo-fencing profile in 704 of permissible physical locations. The end-user device is activated in 706 by the customer for each user and the location-enabled device can be physically attached to the end-user. End-user location data is periodically or continuously transmitted by the location-enabled mobile device in 708 as defined by the customer. If the physical location of the end-user is within the customer defined boundary for that end-user in 710 the MRMS waits for the next location update from the end-user and again tests for location acceptability. If the current location is at or outside the customer defined boundary for that end-user, the CCM 114 automatically notifies the customer of a location violation in 712. Exemplary applications of this embodiment can include, but are not limited to, patient location monitoring, detainee monitoring, prisoner release program monitoring and day care client physical location monitoring.

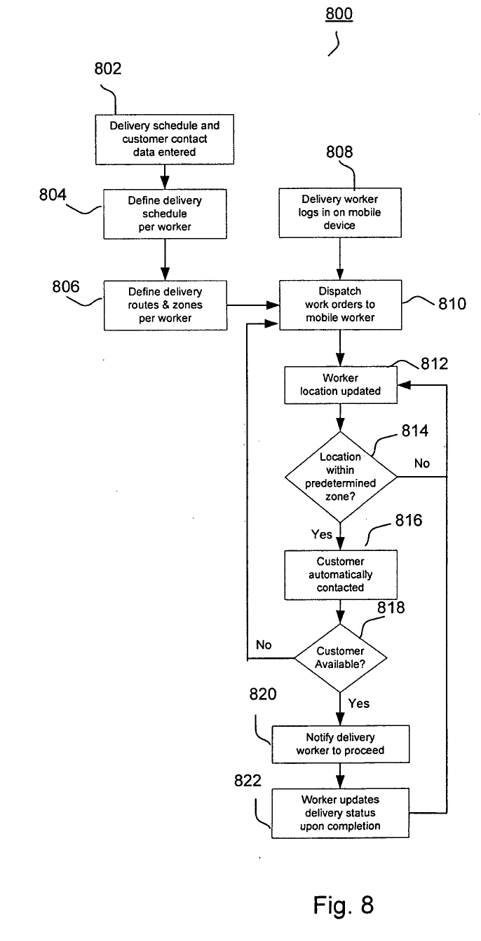

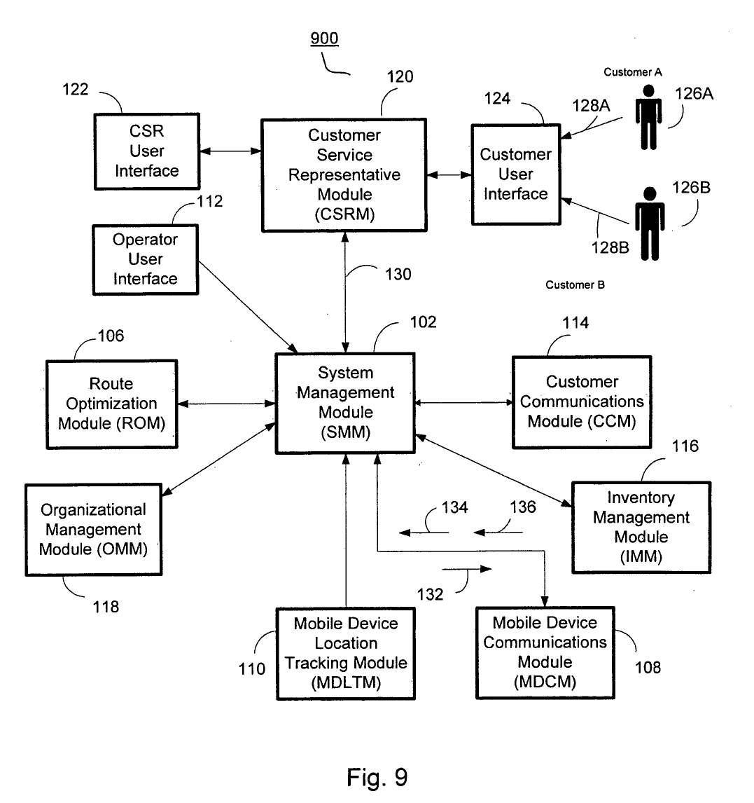

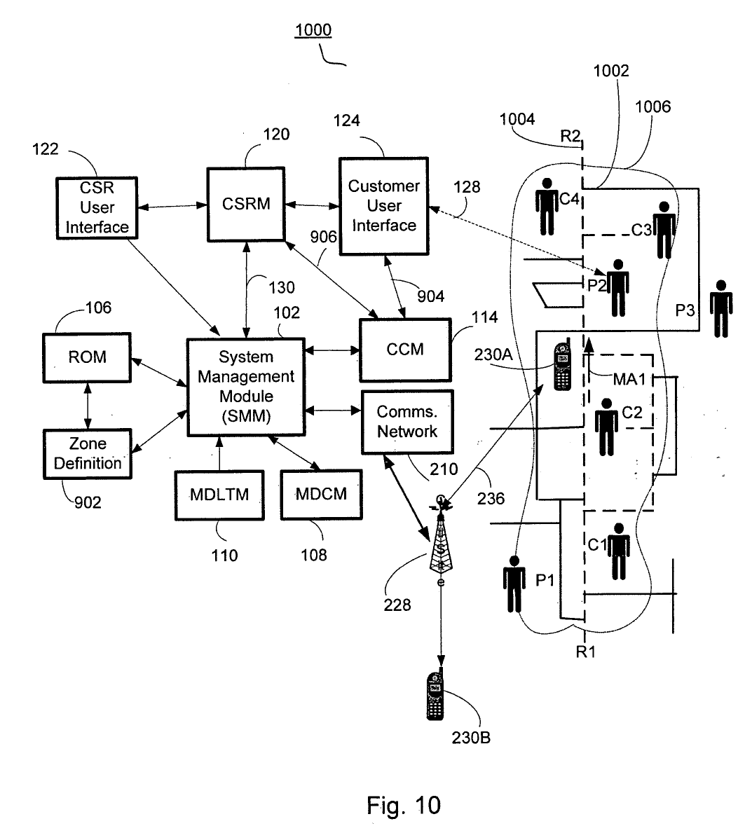

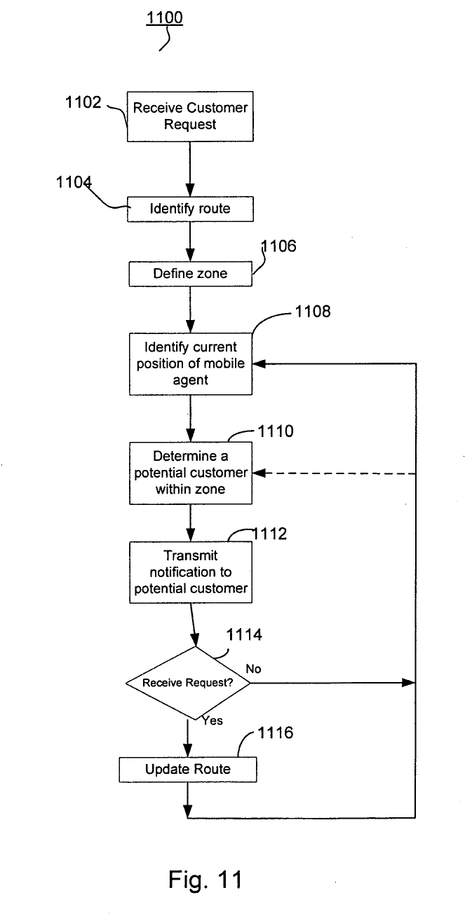

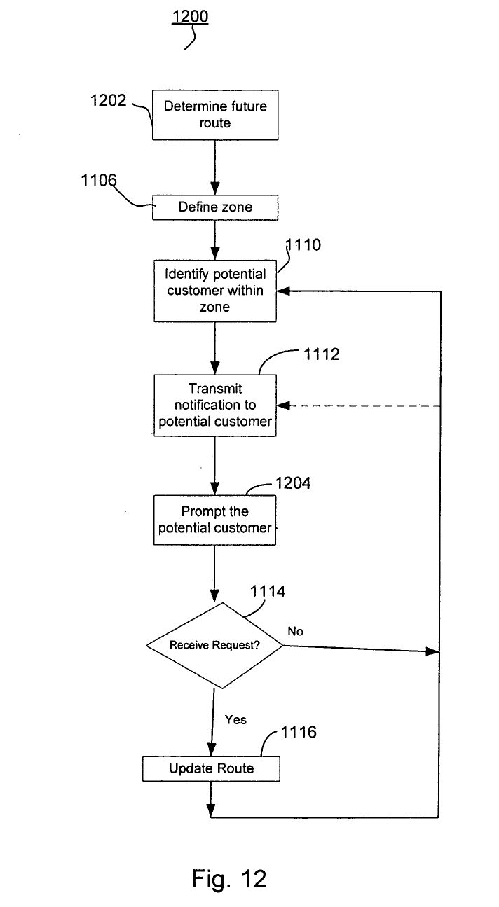

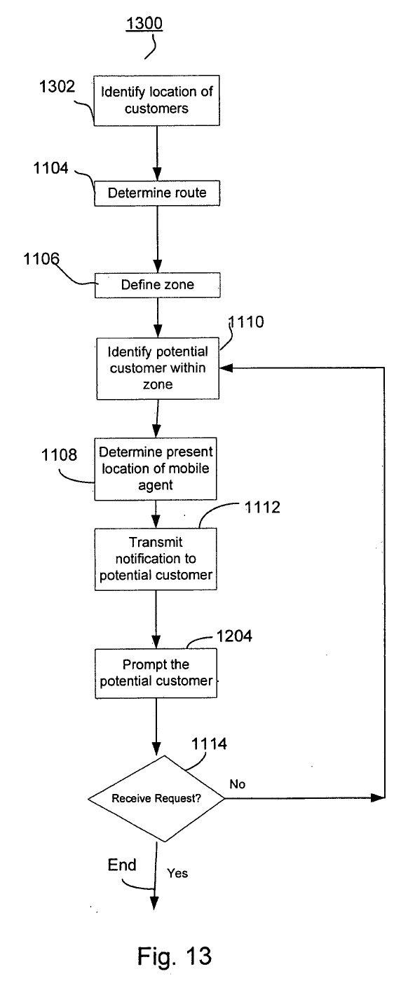

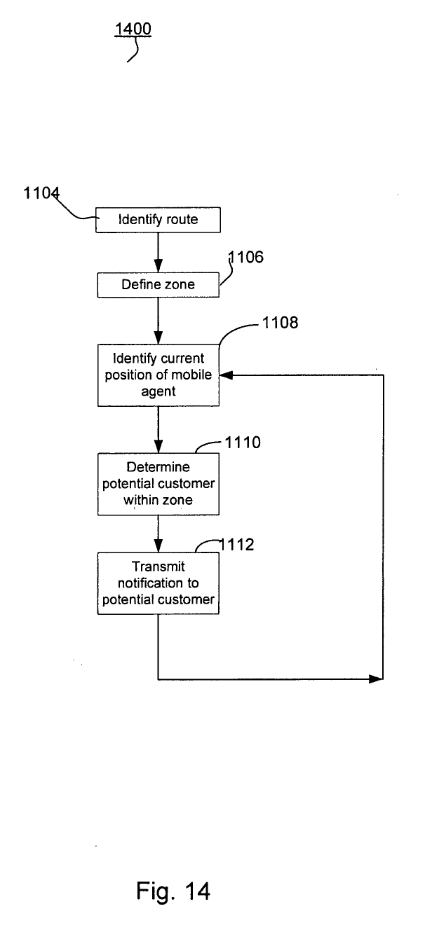

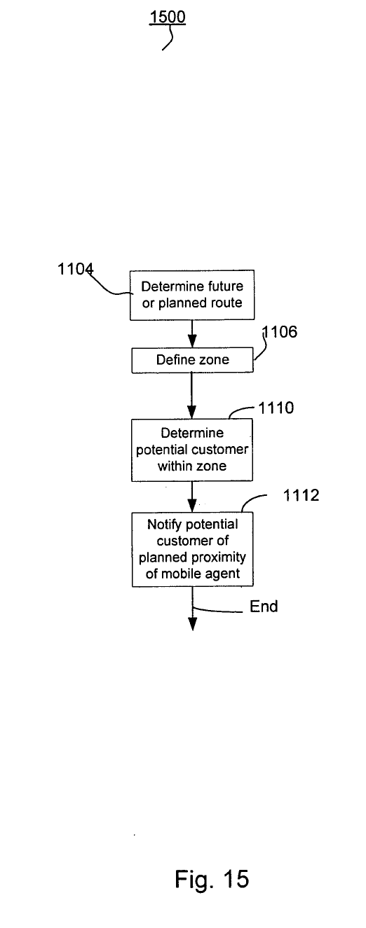

FIG. 8 illustrates another exemplary embodiment of a MRMS 100. In this embodiment, the MRMS manages a plurality of deliveries and a plurality of delivery schedules for a plurality of delivery agents. Delivery schedules and customer contact information are entered into the system in 802; the system defines a plurality of deliveries for each worker's schedule in 804 and defines delivery routes and zones per worker in 806. At the beginning of a worker's scheduled work period/shift, the delivery worker logs in on his location-enabled mobile device in 808, a work order is dispatched to the mobile worker in 810 by the MDCM 108 using end-user defined data templates, the worker's physical location is updated as the worker travels to the first scheduled delivery location in 812. The MRMS checks the worker's physical location against the predetermined geographic zone in 814 and if the worker is within the pre-defined zone, the customer is automatically contacted by the CCM 114 to confirm delivery availability. If the customer is available, the worker is notified 108 to proceed to the scheduled delivery. Upon delivery completion, the worker updates the delivery status in 822, and the worker's location is updated location 812. If the customer is not available or the current delivery has completed, the worker proceeds to the next scheduled delivery and the process repeats.

It should be generally understood that one or more embodiments of the invention can be implemented as computer executable instructions operable on a computer or computing environment. Such instructions can be contained in a memory of the computer or computing environment or can be embodied as computer-readable medium.

Further areas of applicability of the invention will become apparent from the detailed description provided hereinafter. It should be understood that the detailed description and specific examples, while indicating one or more preferred embodiments of the invention, are intended for purposes of illustration only and are not intended to limit the scope of the various embodiments of the invention.

When introducing aspects of the invention or embodiments thereof, the articles “a”, “an”, “the”, and “said” are intended to mean that there are one or more of the elements. The terms “comprising”, “including”, and “having” are intended to be inclusive and mean that there can be additional elements other than the listed elements.

In view of the above, it will be seen that several advantages are achieved and other advantageous results attained by one or more embodiments of the invention. As various changes could be made in the above exemplary constructions and methods without departing from the scope of the invention, it is intended that all matter contained in the above description or shown in the accompanying drawings shall be interpreted as illustrative and not in a limiting sense.

It is further to be understood that the method steps or processes described herein are not to be construed as necessarily requiring their performance in the particular order discussed or illustrated. It is also to be understood that additional or alternative steps or processes can be employed.

The description of the various embodiments of the invention is merely exemplary in nature and, thus, variations that do not depart from the gist of the invention are intended to be within the scope of the invention. Such variations are not to be regarded as a departure from the spirit and scope of the invention.

What is claimed is:

1. A mobile resource management system for managing the arrival of a mobile agent at a location of a customer, the system comprising:
a mobile agent location module for identifying a location of a mobile agent;
a customer communication module configured for transmitting a notification to a customer of an availability of the mobile agent for arrival of the mobile agent at a location of the customer as a function, at least in part, of the identified mobile agent location, prompting the customer to confirm the arrival of the mobile agent at the customer location, and receiving a confirmation from the customer in response to the prompting; and
a mobile agent communication module configured for transmitting schedule and customer appointment information to the mobile agent in response to receiving the customer confirmation.

2. The system of claim 1 wherein the mobile agent communication module is configured for transmitting a customer appointment verification to the mobile agent as a function of, at least in part, the identified mobile agent location.

3. The system of claim 1 wherein the customer communication module is configured for receiving a customer request to delay the appointment to another time during the same day or to reschedule the appointment to another day and the mobile agent communication module is configured for transmitting an appointment change notification to the mobile agent as a function of receiving a customer request to delay or reschedule the appointment.

4. The system of claim 3 wherein the customer is a first customer and the notification is a first notification, wherein the customer communication module is configured for transmitting to a second customer a second notification of the pending arrival of the mobile agent at a location of the second customer for a second appointment and receiving a confirmation from the second customer confirming the second appointment, the transmitting of the second notification to the second customer being in response to receiving a delay request or reschedule request from the first customer.

5. The system of claim 4 wherein the mobile agent communication module is configured for transmitting an instruction to the mobile agent to proceed to the second customer location in response to receiving the second customer confirmation.

6. The system of claim 1, further including a mobile agent management module configured for determining an availability of the mobile agent, wherein the customer communication module is configured for transmitting the notification as a function of the mobile agent management module determining a current or pending availability of the mobile agent.

7. The system of claim 6 wherein the mobile agent management module is configured for determining the availability of the mobile agent as a function of one or more of a location of the mobile agent, the customer location, a location of a second mobile agent, a customer requested arrival time, a customer requested lead time, and a mobile agent transit time.

8. The system of claim 1, further comprising a system management module configured for selecting the mobile agent for the appointment from among a plurality of mobile agents as a function of a location of the mobile agent.

9. The system of claim 8, further comprising a customer service module configured for receiving a request from a customer for delivery of a service or product at the location of the customer, wherein the received customer request includes a customer notification lead time, wherein the system management module is configured for determining an estimated time of arrival of the mobile agent at the customer location as a function of the identified location of the mobile agent and the customer location, and wherein the customer communication module is configured for transmitting the notification to the customer as a function of the customer notification lead time and the estimated time of arrival.

10. The system of claim 1, further comprising a routing module for determining a route between the identified mobile agent location and the customer location, wherein the mobile agent communication module is configured for transmitting the determined route to a mobile agent device associated with the mobile agent.

11. The system of claim 10 wherein the mobile agent location module is configured for identifying locations for each of a plurality of mobile agents and the routing module is configured for determining two or more routes from two or more mobile agents to the customer location, further comprising a mobile agent selection module configured for selecting the mobile agent from among the mobile agents as a function of at least one of two or more identified mobile agent locations and the determined routes, said routing module configured for determining the routes as a function of a route condition parameter including one or more of an optimization factor, a route distance, a time, a transit time, a cost, and a unit cost.

12. A mobile resource management system comprising:
a customer service module for receiving a request from a customer for a service or product, said customer having a customer location;
a mobile agent device associated with each mobile agent and configured for transmitting a signal capable of being used to determine the location of the mobile agent device;
a mobile agent location module for identifying a location of each of a plurality of mobile agents as a function of the transmitted signal;
a system management module configured for determining a task and a task profile as a function of the customer request, determining a status of each of the plurality of agents; selecting a mobile agent to deliver the service or product to the customer from among the plurality of agents as a function of the task profile, the mobile agent status, the customer location, and the mobile agent location;
a customer communication module configured for transmitting a notification to a customer of an availability of the mobile agent for arrival of the mobile agent at a location of the customer as a function, at least in part, of the identified mobile agent location, prompting the customer to confirm the arrival of the mobile agent at the customer location, and receiving a confirmation from the customer in response to the prompting; and
a mobile agent communication module configured for transmitting a customer appointment verification, customer location and task profile to the mobile device associated with the selected mobile agent in response to receiving the customer confirmation.

13. The system of claim 12 wherein the customer request received by the customer service module includes a customer requested delivery time and a customer notification lead time, wherein the system management module is configured for determining an estimated time of arrival of the selected agent at the customer location, selecting the mobile agent as a function of the customer requested delivery time, and the customer notification lead time, and wherein the customer communication module is configured for transmitting the notification to the customer as a function of the customer requested delivery time, the customer notification lead time and the estimated time of arrival.

14. The system of claim 12, further comprising a routing module configured for determining a route between the locations of one or more agents and the customer location, wherein the system management module is configured for selecting the mobile agent as a function of the determined route and a route condition parameter including one or more of an optimization factor, a route distance, a time, a transit time, a cost, and a unit cost, wherein the mobile agent communication module is configured for transmitting the route to the mobile device of the selected mobile agent.

15. The system of claim 12 wherein the mobile device communication module is configured for receiving a mobile agent status message from the mobile device of the mobile agent, said agent status message including a status parameter having one or more of an availability of the mobile agent, a pending availability of the mobile agent, a status of a previously assigned task, a task delivery period, and a task completion time.

16. The system of claim 12 wherein the system management module is configured for selecting the mobile agent for a second task in response to the failure of the customer communication module receiving the customer confirmation in response to the prompting.

17. The system of claim 12 wherein the customer communication module is configured for receiving a customer request to delay the appointment to another time during the same day or to reschedule the appointment to another day, and transmitting an appointment change notification to the mobile agent as a function of receiving the customer request to delay or reschedule the appointment.

18. The system of claim 17 wherein the customer is a first customer and the notification is a first notification, wherein the customer communication module is configured for transmitting a second notification to a second customer of the pending arrival of the mobile agent at a location of the second customer for a second appointment and receiving a confirmation from the second customer confirming the second appointment, the transmitting of the second notification being in response to receiving a delay request or reschedule request from the first customer.

19. The system of claim 18 wherein the mobile agent communication module is configured for transmitting an instruction to the mobile agent to proceed to the second customer location in response to receiving the second customer confirmation.

20. The system of claim 12 wherein the system management module is configured for selecting one or more tasks for the selected mobile agent as a function of the task profile, scheduling the selected tasks for the selected mobile agent and initiating the mobile device communication module to transmit the selected task profiles for the scheduled tasks to the selected mobile agent.

21. The system of claim 20 wherein the system management module is configured for rescheduling the tasks selected for the one mobile agent in response to a failure of the customer communication module receiving a customer confirmation.

22. A method for managing the arrival of a mobile agent at a location of a customer, the method comprising:
identifying a location of the mobile agent having a mobile agent device;
transmitting to a customer a notification of an availability of the mobile agent for arrival of the mobile agent at a location of the customer as a function of the identified agent location;
prompting the customer to confirm the arrival of the mobile agent at the customer location;
receiving a confirmation from the customer in response to the prompting; and
transmitting a customer appointment verification to the mobile agent device in response to receiving the customer confirmation.

23. The method of claim 22 wherein transmitting a customer appointment verification to the mobile agent is a function of the location of the mobile agent.

24. The method of claim 22, further comprising determining an availability of the mobile agent as a function of a one or more of a location of the mobile agent, the customer location, a location of a second mobile agent, a customer requested arrival time, a customer requested lead time, and a mobile agent transit time, wherein transmitting the verification is a function the determined availability of the mobile agent.

25. The method of claim 22, further comprising determining a transit time for the mobile agent to arrive at the customer location and receiving a customer requested arrival time and a notification lead time, wherein transmitting the notification to the customer is a function of a customer requested arrival time, notification lead time, and the determined transit time.

26. The method of claim 22, further comprising prompting the customer to delay the arrival of the mobile agent to another time within the same day or reschedule the arrival of the mobile agent to another day, and receiving a customer request to delay the mobile agent arrival at the customer location in response to the prompting to delay or reschedule.

27. The method of claim 22, further comprising identifying a location of a plurality of mobile agents and selecting one mobile agent for arrival at the customer location from among the mobile agents as a function of a location of the one mobile agent and the customer location.

28. The method of claim 27, further comprising determining a route for each of two or more mobile agents to travel from a first mobile agent location to the customer location and transmitting the route to the selected agent, wherein selecting a mobile agent from among the plurality of mobile agents is a function of the determined routes of the two or more mobile agents.

29. The method of claim 28, further comprising determining a transit time or distance for each mobile agent to travel to the customer location, wherein selecting the mobile agent is a function of the selected mobile agent having a transit time or distance less than a transit time or distance of another agent.

30. The method of claim 22, further comprising:
receiving a request for a service from a plurality of customers;
determining a task profile for a task associated with each service request as a function of each customer service request;
identifying a customer location for each customer service request;
selecting one or more tasks for one mobile agent from among a plurality of mobile agents, the selecting being a function of one or more of the task profile, the customer location, and the mobile agent location;
scheduling the selected tasks for the one mobile agent; and
transmitting the scheduled tasks to the mobile device of the one mobile agent.

31. The method of claim 30, further comprising
receiving a new request from one of the customers; and
assigning a task associated with the new request to a particular agent as a function of a transit distance, a response time, a mobile agent arrival time, and a customer requested time.

32. A computer-readable medium including computer executable instructions to perform the method of claim 22.

33. A method of providing a service or a product to a customer, the method comprising:
receiving a customer request for a delivery of the service or product;
determining a task profile as a function of the customer request;
identifying a location of each of a plurality of agents;
determining a status of each of the plurality of agents;
selecting a mobile agent to deliver the service or product to the customer from among the plurality of mobile agents as a function of the task profile, the mobile agent status, and the mobile agent location; and
transmitting to the customer a notification of a pending arrival of the selected agent at the customer location as a function of the determined agent status and the location of the selected agent;
prompting the customer to confirm the arrival of the mobile agent at the customer location;
receiving a confirmation from the customer in response to the prompting; and
transmitting a customer appointment verification and the task profile to the mobile agent device in response to receiving the customer confirmation.

34. The method of claim 33 wherein each of the mobile agents has a mobile agent profile and wherein selecting the mobile agent is a function of the mobile agent profile, wherein the mobile agent profile has a mobile agent characteristic including one or more of a skill, a certification, a grouping, a geographic allocation, a rating, and an equipment characteristic.

35. The method of claim 33, further comprising entering a status into a mobile device by the mobile agent, wherein the determined status of the mobile agent is received from the mobile device and the determined status of the mobile agent includes a status parameter having one or more of an availability of the mobile agent, a pending availability of the mobile agent, a status of a previously assigned task, a task delivery period, and a task completion time.

36. The method of claim 33, further comprising selecting the mobile agent for another task in response to failing to receive an confirmation from the customer in response to transmitting the notification to the customer.

37. The method of claim 33, further comprising rescheduling the delivery of the service or product to the customer in response to failing to receive an confirmation from the customer in response to transmitting the notification to the customer.

38. A computer-readable medium including computer executable instructions to perform the method of claim 33.
